(19) United States
(12) Patent Application Publication
(10) Pub. No.: US 2025/0136216 A1
(43) Pub. Date: May 1, 2025

(54) CONVEYANCE SEAT

(71) Applicant: TS TECH CO., LTD., Asaka-shi, Saitama (JP)

(72) Inventors: Tomohisa CHIBA, Tochigi (JP); Shinichiro MOTODA, Tochigi (JP); Kazuhiro TSURUMI, Tochigi (JP); Katsuhiro KIYA, Tochigi (JP); Yuta YAGUCHI, Tochigi (JP); Kenshiro WAKAO, Tochigi (JP); Toru ISHIZAKI, Tochigi (JP); Yoichi TAKAHASHI, Tochigi (JP)

(21) Appl. No.: 18/834,559

(22) PCT Filed: Jan. 30, 2023
(86) PCT No.: PCT/JP2023/002924

§ 371 Date: Jul. 30, 2024

Related U.S. Application Data
(60) Provisional application No. 63/304,943, filed on Jan. 31, 2022.
(60) Provisional application No. 63/321,245, filed on Mar. 18, 2022.
(60) Provisional application No. 63/322,333, filed on Mar. 22, 2022.

(30) Foreign Application Priority Data
Mar. 16, 2022 (JP) 2022-041742

(51) Int. Cl. B62J 1/18; B60N 2/58; B62J 9/26

(52) U.S. Cl. CPC B62J 1/18; B60N 2/5883; B62J 9/26

(57) ABSTRACT

There is provided a conveyance seat that ensures decorativeness and that does not impair seating comfort of a seated occupant. A conveyance seat includes a bottom plate; a pad material disposed on the bottom plate; a skin material covering the bottom plate and the pad material; and a decorative member formed separately from the skin material, and attached to the skin material to be exposed on a surface of the seat. The decorative member has a three-dimensional shape, and an exposed surface of the decorative member exposed on the surface of the seat and a surface of the skin material are substantially flush with each other.

### TECHNICAL FIELD

The present invention relates to a conveyance seat, particularly to a conveyance seat including a decorative member attached to be exposed on a surface of a seat.

### BACKGROUND ART

Conventionally, a saddle-type conveyance seat which is configured by covering a pad material with a skin material, the pad material being disposed on a bottom plate, and in which a decorative member is attached to be exposed on a surface of the seat has been known (for example, refer to PATENT LITERATURE 1).

A motorcycle seat (waterproof seat) described in PATENT LITERATURE 1 includes a pad material; a skin material covering the pad material; and a bead (decorative member) formed separately from the skin material, and attached to the skin material to be exposed on a surface of the seat.

The skin material includes a first skin material and a second skin material, and the first skin material and the second skin material are connected to each other via the bead. The bead is welded to a skin terminal portion of the first skin material and a skin terminal portion of the second skin material, and extends long along the surface of the seat in a state where the bead protrudes from the surface of the seat.

The bead can ensure waterproofness and enhance decorativeness (design).

### CITATION LIST

### Patent Literature

PATENT LITERATURE 1: JP 2001-48074 A

### SUMMARY OF INVENTION

### Technical Problem

By the way, in the conveyance seat as described in PATENT LITERATURE 1, since the bead (decorative member) is attached in a state where the bead protrudes from the surface of the seat, decorativeness can be enhanced, but seating comfort of a seated occupant is impaired, which is a risk. Specifically, when the seated occupant is seated on the conveyance seat, the legs of the seated occupant hit the bead, which is a risk.

An object of the present invention is to provide a conveyance seat that does not impair seating comfort of a seated occupant while ensuring decorativeness (design).

In addition, another object of the present invention is to provide a conveyance seat in which a decorative member does not impair seating comfort while the decorative member ensures decorativeness when the decorative member is provided on a surface of the seat.

### Solution to Problem

The above-described problems are solved by a conveyance seat of the present invention, the conveyance seat including: a pad material; a skin material covering the pad material; and a decorative member formed separately from the skin material, and attached to the skin material to be exposed on a surface of the conveyance seat. An exposed surface of the decorative member exposed on the surface of the conveyance seat and a surface of the skin material are substantially flush with each other.

With the above-described configuration, the conveyance seat that does not impair seating comfort of a seated occupant while ensuring decorativeness (design) can be realized.

In detail, since the decorative member is exposed on the surface of the conveyance seat, decorativeness can be ensured. In addition, since the exposed surface of the decorative member and the surface of the skin material are substantially flush with each other, when the seated occupant is seated on the conveyance seat, the legs of the seated occupant do not hit the decorative member, and a decrease in seating comfort can be suppressed.

In this case, it is preferable that the decorative member has a three-dimensional shape, and that the exposed surface extends long along the surface of the conveyance seat.

With the above-described configuration, the decorativeness by the decorative member can be further enhanced.

In this case, it is preferable that a bottom plate, the pad material disposed on the bottom plate, and the skin material covering the bottom plate and the pad material are provided, that a skin terminal portion that is a terminal portion of the skin material is attached to the bottom plate, and that the decorative member is disposed on a portion of the surface of the conveyance seat, the portion coming into contact with a seated occupant when the seated occupant is seated on the conveyance seat.

With the above-described configuration, for example, in a saddle-type conveyance seat, even when the decorative member is disposed at a portion that comes into contact with the seated occupant, impairment of seating comfort of the seated occupant can be suppressed since the decorative member does not protrude.

In this case, it is preferable that the decorative member is stitched and attached to the skin material.

With the above-described configuration, binding strength between the skin material and the decorative member can be increased.

In this case, it is preferable that a stitching line is formed on the surface of the skin material by stitching the decorative member, that the exposed surface of the decorative member extends long along the surface of the conveyance seat, and that the stitching line extends long at a predetermined interval from the exposed surface, together with the exposed surface.

With the above-described configuration, the decorative member and the stitching line can even further enhance decorativeness.

In this case, it is preferable that the decorative member includes a decorative portion having the exposed surface, and a base portion which is provided on a surface on an opposite side of the decorative portion from an exposed surface side, and to which a part of the skin material is attached by stitching.

With the above-described configuration, it becomes clear that the skin material is stitched to the base portion of the decorative member. For this reason, attachment work of the decorative member can be facilitated.

In addition, since the skin material is stitched to the base portion of the decorative member instead of the decorative portion, unintentional impairment of decorativeness can be suppressed.

In this case, it is preferable that the base portion is formed to be wider than the decorative portion, and that a projecting portion of the base portion which projects from the decorative portion is stitched to the part of the skin material.

With the above-described configuration, a contact area between the base portion of the decorative member and the skin material can be increased, and the binding strength between the skin material and the decorative member can be further increased.

In addition, attachment work of the decorative member can be further facilitated.

In this case, it is preferable that the skin material includes a first skin material and a second skin material, that the first skin material and the second skin material are connected to each other via the decorative member, that the first skin material includes a first overlapping portion where a skin terminal portion overlaps in a thickness direction of the skin material by folding the skin terminal portion to a pad material side, the skin terminal portion being located on a second skin material side, that the second skin material includes a second overlapping portion where a skin terminal portion overlaps in the thickness direction of the skin material by folding the skin terminal portion to the pad material side, the skin terminal portion being located on a first skin material side, and that each of the first overlapping portion and the second overlapping portion is attached to the decorative member.

With the above-described configuration, the terminal portion (cut end) of each of the first skin material and the second skin material can be folded inward, and an appearance around the decorative member can be improved.

In this case, it is preferable that the decorative member includes a decorative portion having the exposed surface, and a base portion which is provided on a surface on an opposite side of the decorative portion from an exposed surface side, and to which the skin terminal portions of the skin material are attached by stitching, and that the decorative member is attached between the first skin material and the second skin material by stitching together the first overlapping portion and the base portion, and stitching together the second overlapping portion and the base portion.

With the above-described configuration, since the first skin material and the second skin material are stitched to the base portion of the decorative member, the appearance of the decorative member can be improved.

In addition, binding strength between the decorative member and both the first skin material and the second skin material can be increased.

In this case, it is preferable that the base portion is formed to be wider than the decorative portion, that a first projecting portion of the base portion which projects from the decorative portion is stitched to the skin terminal portion of the first skin material, that a second projecting portion of the base portion which projects toward a side opposite to the first projecting portion is stitched to the skin terminal portion of the second skin material, and that the exposed surface of the decorative member and right and left stitching lines formed at intervals on both sides of the exposed surface extend long along the surface of the conveyance seat.

With the above-described configuration, the exposed surface of the decorative member and the right and left stitching lines can even further enhance decorativeness.

### Advantageous Effects of Invention

According to the present invention, the conveyance seat that does not impair seating comfort of the seated occupant while ensuring decorativeness (design) can be realized.

In addition, according to the present invention, decorativeness by the decorative member can be further enhanced.

In addition, according to the present invention, for example, in a saddle-type conveyance seat, impairment of seating comfort of the seated occupant can be suppressed.

In addition, according to the present invention, the binding strength between the skin material and the decorative member can be increased.

In addition, according to the present invention, the decorative member and the stitching lines can even further enhance decorativeness.

In addition, according to the present invention, attachment work of the decorative member can be facilitated.

In addition, according to the present invention, an appearance around the decorative member and the appearance of the decorative member can be improved.

### BRIEF DESCRIPTION OF DRAWINGS

FIG. 1 is a side view of a conveyance (motorcycle) of a first embodiment.

FIG. 2 is a perspective view of a conveyance seat.

FIG. 3 is a partial cross-sectional view of the conveyance seat, and is a view showing a bottom plate, a pad material, a skin material, and a decorative member.

FIG. 4 is an enlarged view of main portions of FIG. 3, and is a view showing the decorative member.

FIG. 5 is an enlarged view of main portions of FIG. 3, and is a view showing Modification example 1-1 of the decorative member.

FIG. 6 is a view showing Modification example 1-2 of the decorative member.

FIG. 7 is a view showing Modification example 1-3 of the decorative member.

FIG. 8 is a view showing Modification example 1-4 of the decorative member.

FIG. 9 is a view showing Modification example 1-5 of the decorative member.

FIG. 10 is a view showing Modification example 1-6 of the decorative member.

FIG. 11 is a side view of a conveyance (motorcycle) of a second embodiment.

FIG. 12 is a perspective view of a conveyance seat.

FIG. 13 is a view describing a method for forming a decorative member (decorative skin).

FIG. 14A is a cross-sectional view of the conveyance seat, and is a view showing a skin material and the decorative member.

FIG. 14B is a view showing Modification example 2-1 of the decorative member.

FIG. 14C is a view showing Modification example 2-2 of the decorative member.

FIG. 15 is a view describing a method for forming a decorative member.

FIG. 16 is a perspective view of the conveyance seat, and is a view showing a configuration of the decorative members.

FIG. 17 is a cross-sectional view of the conveyance seat, and is a view showing the decorative member and a heater wire.

FIG. 18 is a cross-sectional view of the conveyance seat, and is a view showing the decorative member, a stitching line, and waterproof tape.

FIG. 19 is a view showing a disposition pattern of holes formed in a lining material.

FIG. 20 is a view showing a Modification example of the disposition pattern of the holes.

FIG. 21 is a view showing Modification example 2-3 of the decorative member, and is a perspective view of a vehicle seat.

FIG. 22 is a side view of a conveyance (motorcycle) of a third embodiment.

FIG. 23 is an exploded perspective view of a conveyance seat and an exterior cover (fuel tank cover).

FIG. 24 is a side cross-sectional view of the conveyance seat and the exterior cover.

FIG. 25 is a perspective view of a trim member.

FIG. 26 is a side cross-sectional view of the conveyance seat, and is an enlarged view of main portions of the trim member.

FIG. 27A is a perspective view of the trim member (positioning portion).

FIG. 27B shows Modification example 1 of the trim member (positioning portions).

FIG. 27C shows Modification example 2 of the trim member (positioning portion).

FIG. 28A is a perspective view of the trim member (projection portion).

FIG. 28B shows Modification example 3 of the trim member (projection portions).

FIG. 28C shows Modification example 4 of the trim member (projection portions).

FIG. 29 shows Modification example 5 of the trim member.

FIG. 30 is a side view of a conveyance (motorcycle) of a fourth embodiment.

FIG. 31 is a perspective view of a conveyance seat (including a pocket).

FIG. 32 is a top view of the conveyance seat, and is a view showing an enlarged view of main portions of the pocket.

FIG. 33 is a view showing details of the pocket.

FIG. 34 is a side cross-sectional view of the conveyance seat, and is a view showing a state where the pocket is at a “use position”.

FIG. 35 is a view showing a state where the pocket is at a “storage position”.

### DESCRIPTION OF EMBODIMENTS

### First Embodiment

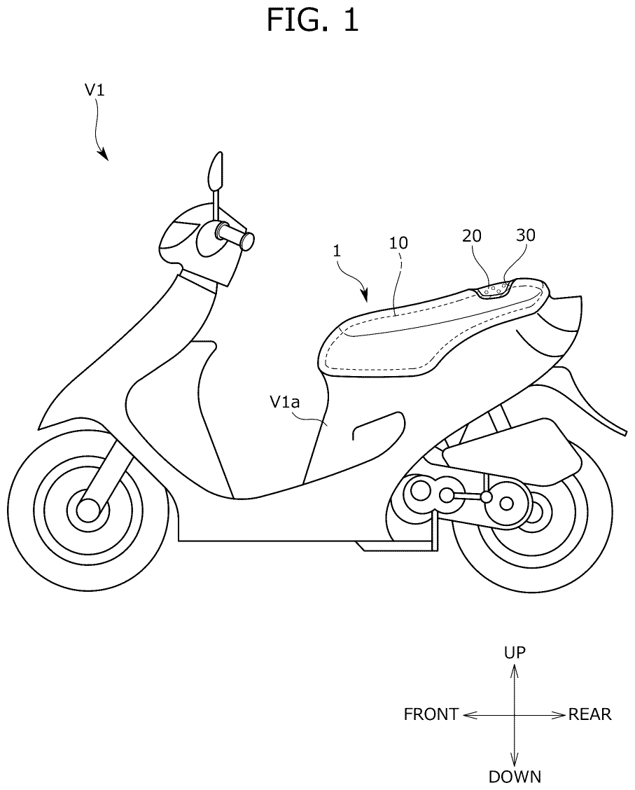

Hereinafter, a first embodiment will be described with reference to FIGS. 1 to 10.

The first embodiment relates to an invention of a conveyance seat including: a pad material; a skin material covering the pad material; and a decorative member formed separately from the skin material, and attached to the skin material to be exposed on a surface of the conveyance seat. An exposed surface of the decorative member exposed on the surface of the seat and a surface of the skin material are substantially flush with each other.

Incidentally, a side on which a steering wheel of a conveyance is disposed with respect to the conveyance seat is a seat front side.

As shown in FIGS. 1 to 3, a conveyance seat 1 is a seat constituting a seating portion of a motorcycle V1, and mainly includes a bottom plate 10 attached onto a vehicle body V1a and serving as a base substrate; a pad material 20 placed on the bottom plate 10; a skin material 30 covering the bottom plate 10 and the pad material 20; and a decorative member 40 formed separately from the skin material 30, and attached to the skin material 30 to be exposed on a surface of the conveyance seat 1.

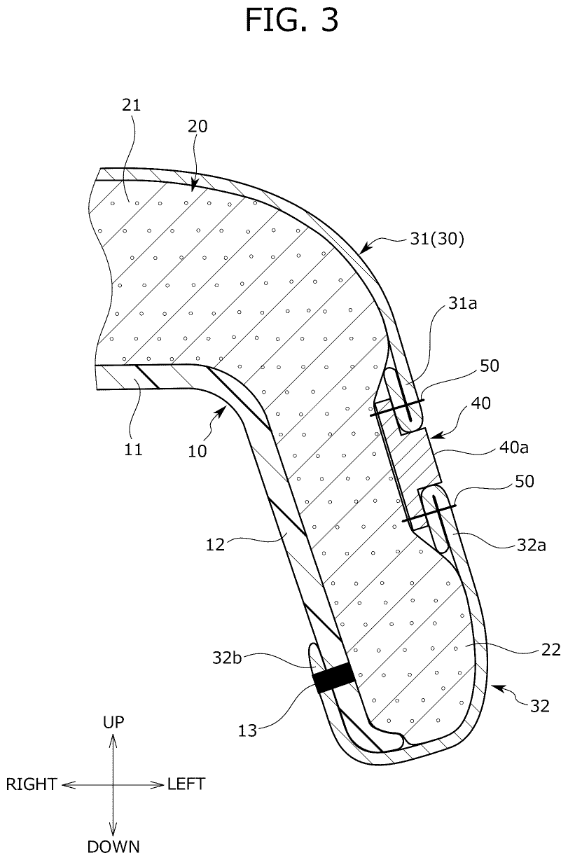

Incidentally, in the conveyance seat 1, as shown in FIG. 3, skin terminal treatment is performed by attaching a skin terminal portion, which is a terminal portion of the skin material 30, to a back surface of the bottom plate 10. Specifically, an attachment member 13 such as a tacker needle is used for the skin terminal treatment.

As shown in FIGS. 1 and 3, the bottom plate 10 is a plate that is long in a seat front to rear direction, and serves as a base substrate of the seat 1, which is formed in a curved shape to match the outer shape of the vehicle body V1a.

Specifically, the bottom plate 10 mainly includes a plate body portion 11 that is a body portion of the bottom plate 10, and a plate outer peripheral portion 12 that is a flange portion formed by bending an outer peripheral portion of the plate body portion 11 diagonally downward.

The bottom plate 10 is formed as a synthetic resin-molded product using a resin material such as polypropylene or polyethylene as a raw material.

Incidentally, the bottom plate 10 is not limited to the above-described resin material, and may be made of various materials. For example, a resin material having a relatively high bending modulus, such as glass fiber-reinforced polypropylene (GFPP), may be used as the raw material.

As shown in FIGS. 1 and 3, the pad material 20 is a cushion pad that is formed of an elastic member for which urethane foam or the like is used, and that is long in the seat front to rear direction, and is formed to be slightly larger than the outer shape of the bottom plate 10.

Specifically, the pad material 20 includes a pad body portion 21 that is a body portion of the pad material 20, and a pad projecting portion 22 projecting from an outer peripheral portion of the pad body portion 21, and extending along a surface of the plate outer peripheral portion 12 of the bottom plate 10.

As shown in FIG. 3, the pad projecting portion 22 is provided to surround the bottom plate 10 from the outside over substantially the entire circumference.

As shown in FIGS. 1 to 4, the skin material 30 is a covering material constituting the appearance of the seat 1, is formed of a covering material for which polyvinyl chloride (PVC) leather or the like is used, and is formed, for example, by laminating a soft polyvinyl chloride layer to a surface of a fabric.

Polyvinyl chloride leather or the like is adopted as the material for the skin material 30, and is suitable as a skin material for a motorcycle which is directly exposed to wind and rain.

In addition, by making the skin material 30 using a material that is relatively difficult to stretch, the attachment strength of the skin material 30 can be ensured while ensuring the design of the seat surface (while preventing wrinkles or looseness from occurring).

Incidentally, when the seat 1 is a seat directly exposed to wind and rain, it is preferable that the skin material 30 is made of a resin material with water resistance such as a polyvinyl chloride material. On the other hand, when the seat 1 is an automobile seat or the like that is not directly exposed to wind and rain, the skin material 30 may be made of various materials.

The skin material 30 includes a first skin material 31 constituting an upper surface, side surfaces, and a rear surface of the seat 1; a second skin material 32 constituting lower portions of the side surfaces and a lower portion of the rear surface of the seat 1; and a third skin material 33 constituting a front surface of the seat 1.

In other words, it can also be said that the skin material 30 mainly includes a first skin piece (first skin material 31), a second skin piece (second skin material 32), and a third skin piece (third skin material 33).

Incidentally, the skin material 30 may include one skin material, may include two skin materials (the first skin material 31 and the second skin material), or may include four or more skin materials.

The first skin material 31 is connected to the second skin material 32 by connecting a skin terminal portion 31a of the first skin material 31 and a skin terminal portion 32a of the second skin material 32 to each other via the decorative member 40.

In addition, the first skin material 31 is connected to the third skin material 33 by directly connecting a skin terminal portion 31b of the first skin material 31 and a skin terminal portion 33a of the third skin material 33 through stitching.

Incidentally, a skin terminal portion 32b of the second skin material 32 and the skin terminal portion 33a of the third skin material 33 are attached to the back surface of the bottom plate 10.

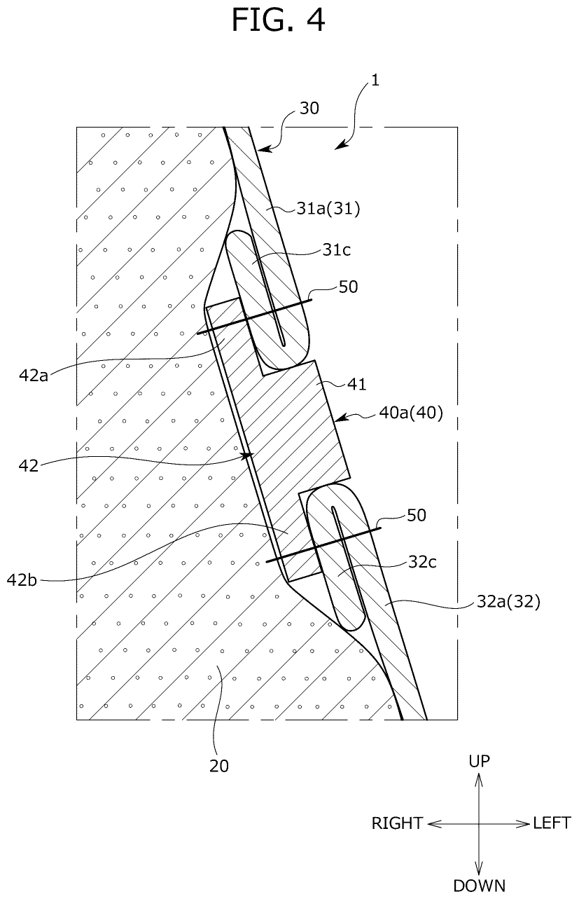

As shown in FIGS. 3 and 4, the first skin material 31 includes a first overlapping portion 31c where the skin terminal portion 31a overlaps in a thickness direction of the skin material 30 by folding the skin terminal portion 31a toward a pad material 20 side, the skin terminal portion 31a being located on a second skin material 32 side.

In addition, the second skin material 32 includes a second overlapping portion 32c where the skin terminal portion 32a overlaps in the thickness direction of the skin material 30 by folding the skin terminal portion 32a to the pad material 20 side, the skin terminal portion 32a being located on a first skin material 31 side.

Each of the first overlapping portion 31c and the second overlapping portion 32c is attached to the decorative member 40.

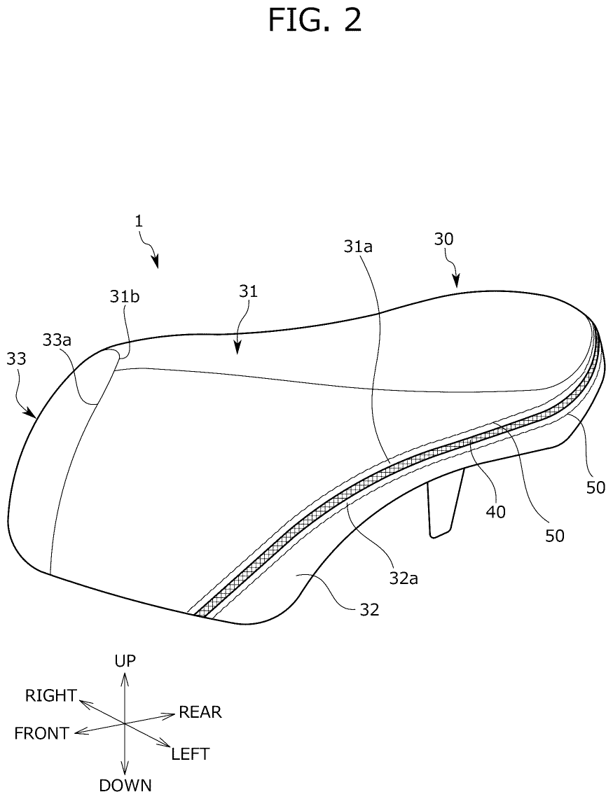

As shown in FIGS. 2 to 4, the decorative member 40 is a three-dimensional decorative member attached to the skin material 30 to be exposed on the side surfaces and the rear surface of the seat 1, and is, for example, a bead (flat bead).

The decorative member 40 is made of a resin material, and is made of, for example, a resin material (rubber material) with water resistance and elasticity.

The decorative member 40 is disposed on a portion of the surface of the seat 1, the portion coming into contact with the legs of a seated occupant when the seated occupant is seated on the seat 1.

Incidentally, the decorative member 40 is not limited to being disposed on the side surfaces and the rear surface of the seat 1. For example, the decorative member 40 may be disposed only on the side surfaces of the seat 1, may be disposed on the front surface, the side surfaces, and the rear surface of the seat 1, or may be disposed on the upper surface of the seat 1.

As shown in FIGS. 3 and 4, the decorative member 40 is stitched and attached to the skin material 30 (the first skin material 31 and the second skin material 32). An exposed surface 40a of the decorative member 40, which is exposed on the surface of the seat 1, and a surface of the skin material 30 are substantially flush with each other.

Here, the term “substantially flush state” refers to including a state where the exposed surface 40a slightly protrudes from the surface of the skin material 30 and a state where the exposed surface 40a is slightly recessed from the surface of the skin material 30 in addition to a state where the exposed surface 40a and the surface of the skin material 30 are substantially flush with each other.

As shown in FIG. 2, the exposed surface 40a of the decorative member 40 extends long along the surface of the seat 1.

In detail, the exposed surface 40a extends from a front portion of the left side surface of the seat 1 to a rear end portion, extends long in a seat width direction from the rear end portion along the rear surface of the seat 1, and extends in the seat front to rear direction from the rear surface of the seat 1 along the right side surface of the seat 1 to reach a front portion of the right side surface of the seat 1.

In addition, stitching lines 50 are formed on the surface of the skin material 30 by stitching the decorative member 40.

The exposed surface 40a extends long along the surface of the seat 1, and the stitching lines 50 extend long at a predetermined interval from the exposed surface 40a, together with the exposed surface 40a.

As shown in FIGS. 3 and 4, the decorative member 40 includes a decorative portion 41 having the exposed surface 40a, and a base portion 42 which is provided on a surface (back surface) on an opposite side of the decorative portion 41 from the exposed surface 40a, and to which the skin terminal portions of the skin material 30 are attached by stitching.

The base portion 42 is formed to be wider than the decorative portion 41. Projecting portions of the base portion 42 which project from the decorative portion 41 are stitched to the skin terminal portions of the skin material 30.

Incidentally, the decorative member 40 is a substantially flat plate-shaped member (flat bead), but is not particularly limited thereto. The degree of freedom in design can be increased by adopting preferably the flat bead.

In the above-described configuration, as shown in FIG. 4, the first overlapping portion 31c of the first skin material 31 and the base portion 42 are stitched together, and the second overlapping portion 32c of the second skin material 32 and the base portion 42 are stitched together. Furthermore, the decorative member 40 is attached between the first skin material 31 and the second skin material 32.

In other words, a portion of the first skin material 31 (second skin material 32) which is exposed on the surface, an inward folded portion of the first skin material 31 (second skin material 32), and the base portion 42 of the decorative member 40 are stitched together in an overlapping state.

As a result, the first skin material 31 and the second skin material 32 can be stitched to the base portion 42 of the decorative member 40 instead of the decorative portion 41, and the appearance of the decorative member 40 can be improved.

In addition, binding strength between the decorative member 40 and both the first skin material 31 and the second skin material 32 can be increased.

In addition, in the above-described configuration, as shown in FIG. 4, a first projecting portion 42a of the base portion 42 which projects from the decorative portion 41 is stitched to the skin terminal portion 31a of the first skin material 31. Furthermore, a second projecting portion 42b of the base portion 42 which projects toward a side opposite to the first projecting portion 42a is stitched to the skin terminal portion 32a of the second skin material 32. Furthermore, the exposed surface 40a of the decorative member 40 and the right and left stitching lines 50 formed at intervals on both sides of the exposed surface 40a extend long along the surface of the seat 1.

As a result, the exposed surface 40a of the decorative member 40 and the right and left stitching lines 50 can even further enhance decorativeness.

### <<Modification Examples of Decorative Member>>

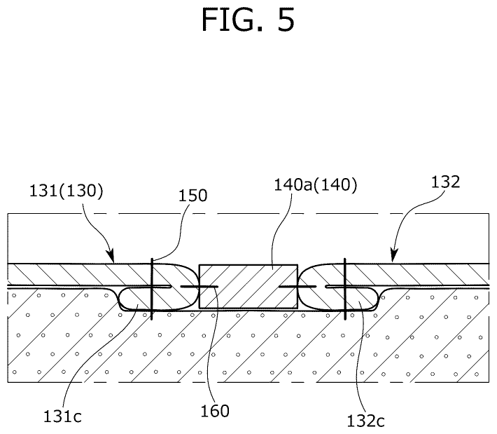

Next, Modification examples 1-1 to 1-6 of the decorative member will be described based on FIGS. 5 to 10. Incidentally, the description of contents that overlap with those of the decorative member 40 described above will be omitted.

### <<Modification Example 1-1>>

As shown in FIG. 5, a decorative member 140 of Modification example 1-1 is a decorative member having a substantially rectangular cross-sectional shape, and an exposed surface 140a of the decorative member 140 and a surface of a skin material 130 are substantially flush with each other.

A first skin material 131 includes a first overlapping portion 131c formed by folding and stitching a skin terminal portion of the first skin material 131. In addition, a second skin material 132 includes a second overlapping portion 132c formed by folding and stitching a skin terminal portion of the second skin material 132.

A stitching line 150 is formed on each of surfaces of the first overlapping portion 131c and the second overlapping portion 132c.

The decorative member 140 is connected to the first skin material 131 by stitching together a side portion of the decorative member 140 and the first overlapping portion 131c.

In addition, the decorative member 140 is connected to the second skin material 132 by stitching together a side portion of the decorative member 140 and the second overlapping portion 132c.

Second stitching lines 160 formed by this stitching are formed not to be exposed on the surface of the seat (not to be visible from the outside of the seat).

With the above-described configuration as well, a conveyance seat in which the decorative member does not impair seating comfort while ensuring decorativeness can be realized.

### <<Modification Example 1-2>>

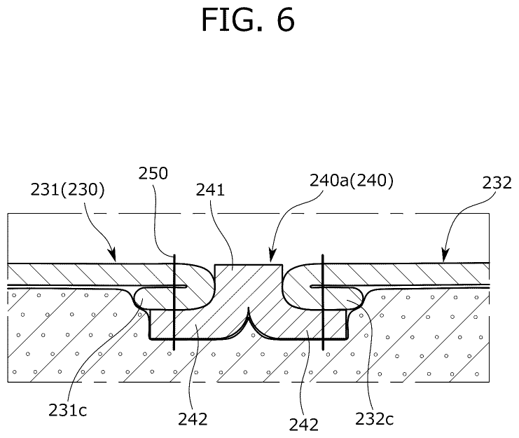

As shown in FIG. 6, a decorative member 240 of Modification example 1-2 includes a decorative portion 241 having an exposed surface 240a, and right and left base portions 242 (right and left leg portions) which are provided on a back surface of the decorative portion 241 and to which skin terminal portions of a skin material 230 are attached by stitching.

The decorative member 240 is connected to a first skin material 231 by stitching together the base portion 242 and a first overlapping portion 231c.

In addition, the decorative member 240 is connected to a second skin material 232 by stitching together the base portion 242 and a second overlapping portion 232c.

A stitching line 250 is formed on each of surfaces of the first overlapping portion 231c and the second overlapping portion 232c.

The right and left base portions 242 protrude opposite to each other from a bottom surface of the decorative portion 241 while being curved, and extend along the first skin material 231 and the second skin material 232, respectively.

In this case, the base portion 242 abuts against the first overlapping portion 231c (second overlapping portion 232c) over substantially the entire surface. In other words, the decorative member 240 is connected to the first skin material 231 and the second skin material 232 such that no gap is formed between the decorative member 240 and both the first skin material 231 and the second skin material 232.

As a result, binding strength between the skin material 230 and the decorative member 240 can be increased, and water resistance of the seat (water resistance of the decorative member 240 and a periphery of the decorative member 240) can be increased. In addition, the appearance of the decorative member 240 can be enhanced.

With the above-described configuration as well, a conveyance seat in which the decorative member does not impair seating comfort while ensuring decorativeness can be realized.

### <<Modification Example 1-3>>

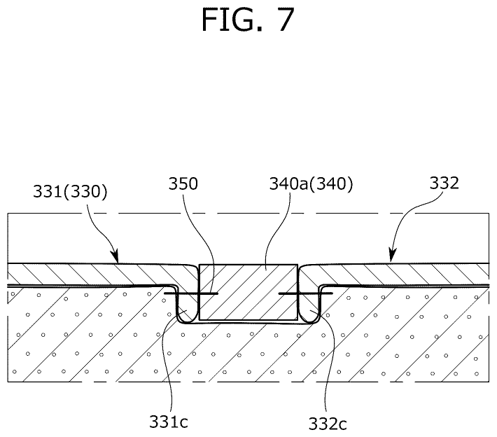

As shown in FIG. 7, a decorative member 340 of Modification example 1-3 is a decorative member having a substantially rectangular cross-sectional shape, and an exposed surface 340a of the decorative member 340 and a surface of a skin material 330 are substantially flush with each other.

A first skin material 331 includes a first folded portion 331c formed by folding a skin terminal portion of the first skin material 331. In addition, a second skin material 332 includes a second folded portion 332c formed by folding a skin terminal portion of the second skin material 332.

The decorative member 340 is connected to the first skin material 331 by stitching together a side portion of the decorative member 340 and the first folded portion 331c.

In addition, the decorative member 340 is connected to the second skin material 332 by stitching together a side portion of the decorative member 340 and the second folded portion 332c.

Stitching lines 350 formed by this stitching are formed not to be exposed on the surface of the seat.

With the above-described configuration as well, a conveyance seat in which the decorative member does not impair seating comfort while ensuring decorativeness can be realized.

### <<Modification Example 1-4>>

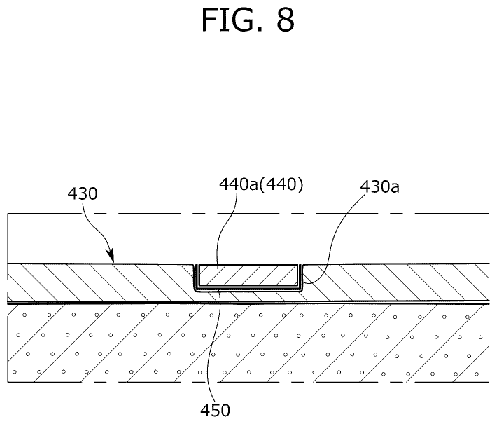

As shown in FIG. 8, a decorative member 440 of Modification example 1-4 is a decorative member having a substantially rectangular cross-sectional shape, and an exposed surface 440a of the decorative member 440 and a surface of a skin material 430 are substantially flush with each other.

The decorative member 440 is accommodated in an accommodation recess 430a formed on the surface of the skin material 430, and is attached to the skin material 430 by an adhesive agent 450.

In detail, an outer peripheral surface and a bottom surface (surfaces excluding exposed surface 440a) of the decorative member 440 are attached to the skin material 430 by the adhesive agent 450.

With the above-described configuration as well, a conveyance seat in which the decorative member does not impair seating comfort while ensuring decorativeness can be realized.

### <<Modification Example 1-5>>

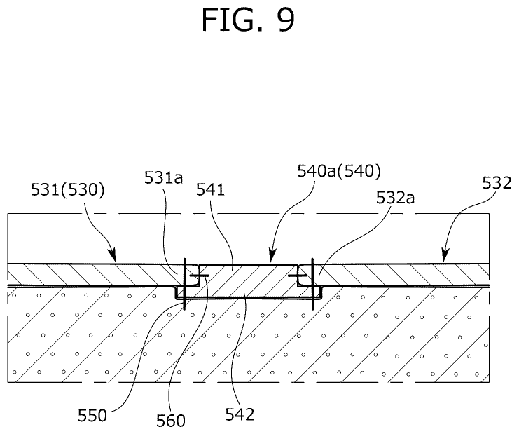

As shown in FIG. 9, a decorative member 540 of Modification example 1-5 includes a decorative portion 541 having an exposed surface 540a, and a base portion 542 provided on a back surface of the decorative portion 241.

The decorative member 540 is connected to a first skin material 531 by stitching together the base portion 542 and a skin terminal portion 531a.

In addition, the decorative member 540 is connected to a second skin material 532 by stitching together the base portion 542 and a skin terminal portion 532a.

A stitching line 550 is formed on each of surfaces of the skin terminal portions 531a and 532a.

The decorative member 540 is connected to the first skin material 531 by stitching together a side portion of the decorative member 540 and the skin terminal portion 531a.

In addition, the decorative member 540 is connected to the second skin material 532 by stitching together a side portion of the decorative member 540 and the skin terminal portion 532a.

Second stitching lines 560 formed by this stitching are formed not to be exposed on the surface of the seat.

With the above-described configuration as well, a conveyance seat in which the decorative member does not impair seating comfort while ensuring decorativeness can be realized.

### <<Modification Example 1-6>>

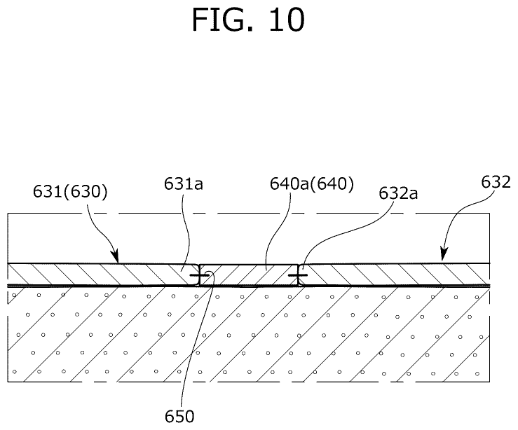

As shown in FIG. 10, a decorative member 640 of Modification example 1-6 is a decorative member having a rectangular cross-sectional shape, and an exposed surface 640a of the decorative member 640 and a surface of a skin material 630 are substantially flush with each other.

The decorative member 640 is connected to a first skin material 631 by stitching together a side portion of the decorative member 640 and a skin terminal portion 631a.

In addition, the decorative member 640 is connected to a second skin material 632 by stitching together a side portion of the decorative member 640 and a skin terminal portion 632a.

Stitching lines 650 formed by this stitching are formed not to be exposed on the surface of the seat.

With the above-described configuration as well, a conveyance seat in which the decorative member does not impair seating comfort while ensuring decorativeness can be realized.

### <<Others>>

In the first embodiment, as shown in FIG. 1, the conveyance seat 1 includes the bottom plate 10 serving as a base substrate, but is not particularly limited thereto.

For example, the conveyance seat 1 may include a seat frame serving as a skeleton of the seat, instead of the bottom plate 10. Alternatively, the bottom plate 10 may not be provided.

In the first embodiment, as shown in FIG. 3, the decorative member 40 has a three-dimensional shape, but is not particularly limited thereto.

For example, the decorative member 40 may be a decorative member having a film shape, a sheet shape, or the like.

In the first embodiment, as shown in FIG. 3, the exposed surface 40a of the decorative member 40 and the surface of the skin material 30 are substantially flush with each other, but are not particularly limited thereto.

The decorative member 40 may not protrude from the surface of the seat. Namely, the decorative member 40 (exposed surface 40a) may be recessed (greatly recessed) from the surface of the skin material 30.

### Second Embodiment

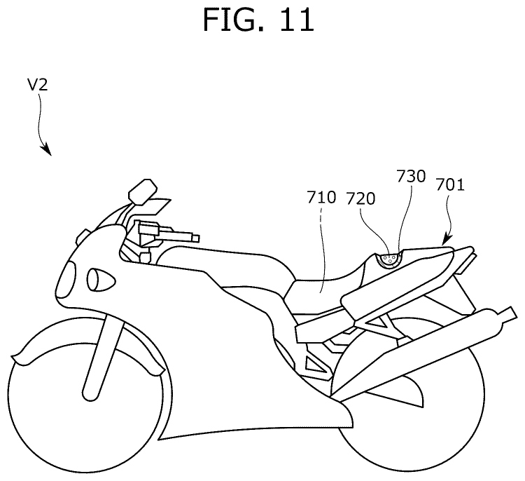

Next, a conveyance seat 701 of a second embodiment will be described based on FIGS. 11 to 17. Incidentally, the description of contents that overlap with those of the conveyance seat 1 described above will be omitted.

The conveyance seat 701 can ensure wear resistance of a decorative portion, and allows the design of the decorative portion to be suitably arranged.

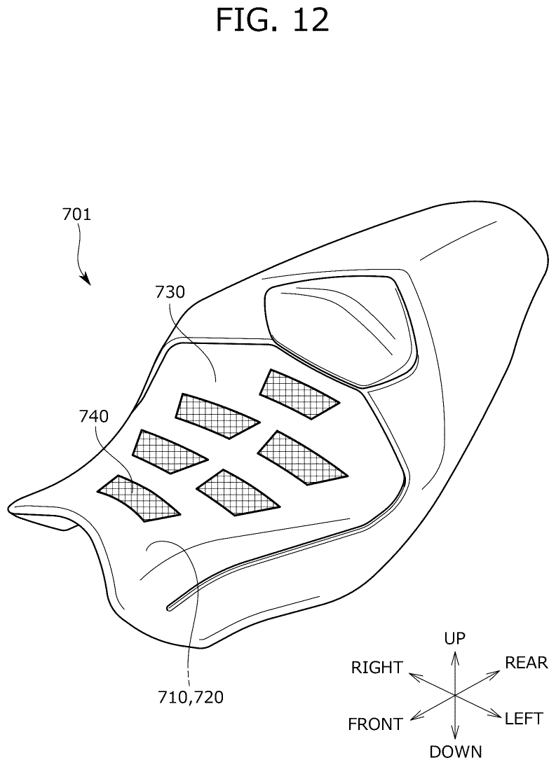

As shown in FIGS. 11 and 12, the conveyance seat 701 is a seat constituting a seating portion of a motorcycle V2, and includes a bottom plate 710; a pad material 720; a skin material 730; and a decorative member 740 attached to a surface of the skin material 730 and exposed on a surface of the conveyance seat 701.

As shown in FIG. 12, the decorative member 740 is a skin material having decorativeness, and is also referred to as a decorative skin material, colored leather, or the like.

A plurality of the decorative members 740 are disposed on the surface of the skin material 730 at predetermined intervals in the seat front to rear direction and the seat width direction.

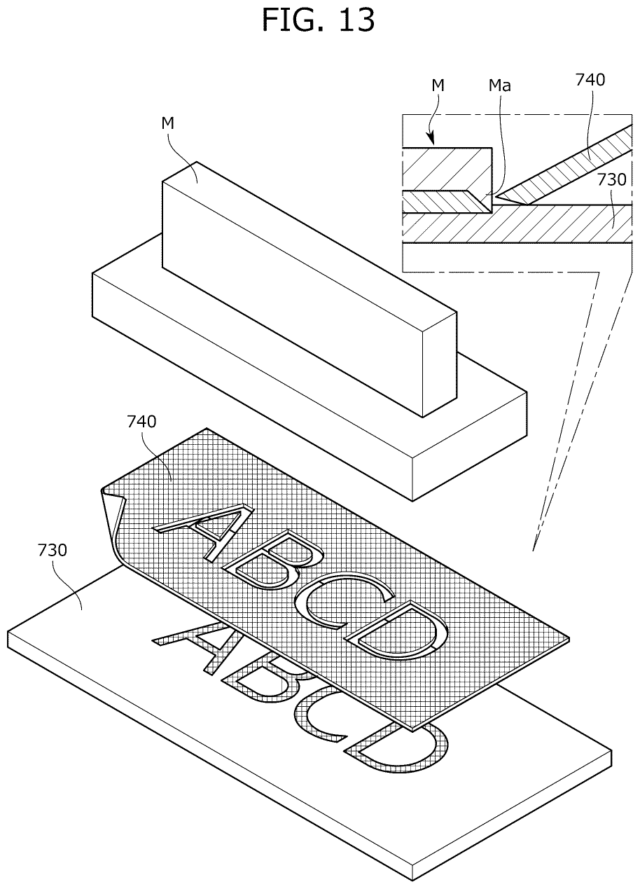

FIG. 13 is a view showing a method for forming the decorative member 740 (decorative skin material).

As shown in FIG. 13, the decorative member 740 can be suitably attached by welding the decorative member 740 onto the skin material 730 serving as a base using a mold M.

At this time, by using the same material for the skin material 730 and the decorative member 740, and performing high-frequency welding using the mold M, wear resistance of the decorative member 740 can be ensured. In addition, in the conventional technique, it is difficult to color-code the skin material 730 and the decorative member 740; however, in the present embodiment, a multicolor design can be applied. In addition, various design needs can be dealt with.

Incidentally, it is preferable that the skin material 730 and the decorative member 740 are made of the same PVC leather. Processability and appearance can be made good by adopting PVC leather. Processing cost can also be suppressed. In addition, the decorative member 740 is less likely to wear.

In addition, as shown in FIG. 13, by providing a protruding portion Ma at an outer edge portion of the mold M, the welding of the decorative member 740 to the skin material 730 and the cutting of the decorative member 740 can be simultaneously performed. For this reason, the processing cost can be suppressed.

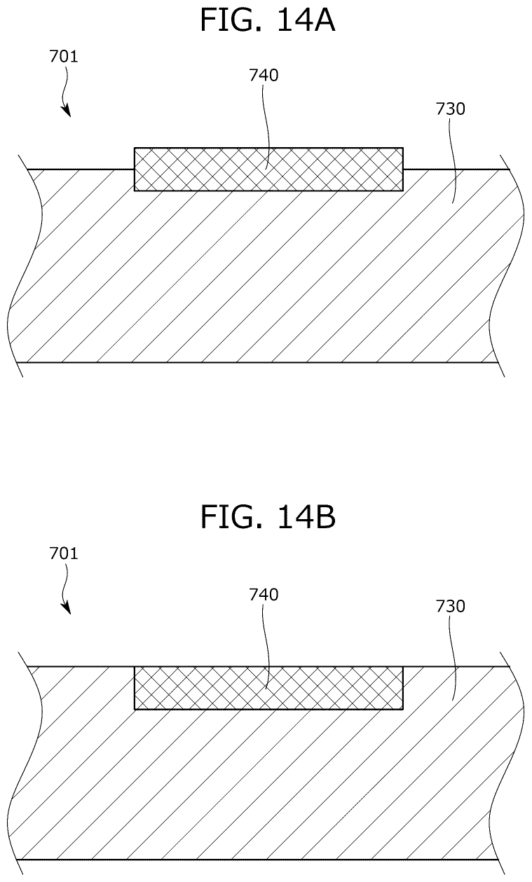

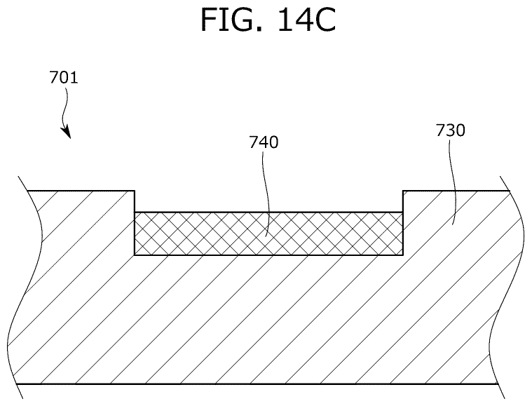

FIG. 14A is a cross-sectional view of the conveyance seat 701, and is a view showing the skin material 730 and the decorative member 740 (decorative skin).

As shown in FIG. 14A, it is preferable that a thickness of the decorative member 740 is set to approximately 15 to 25% of a thickness of the skin material 730. As a result, the unintended formation of irregularities on the surface of the conveyance seat 701 can be suppressed. In addition, emboss processing (embossing) can be suitably performed on the decorative member 740.

As shown in FIG. 14A, the decorative member 740 is disposed to slightly project from the surface of the skin material 730, but is not particularly limited thereto.

As shown in FIG. 14B, the decorative member 740 may be disposed such that a surface of the decorative member 740 and the surface of the skin material 730 are flush with each other. Alternatively, as shown in FIG. 14C, the decorative member 740 may be disposed to be slightly recessed from the surface of the skin material 730.

Incidentally, as shown in FIG. 12, by attaching the decorative members 740, into which a material having an anti-slip property or a pattern is incorporated, to a seating surface of the conveyance seat 701, a slip suppression effect can be imparted to the surface of the conveyance seat 701. In this case, it is preferable that the decorative members 740 having an anti-slip property are attached to portions of the seating surface which are subjected to a high load caused by a seating weight.

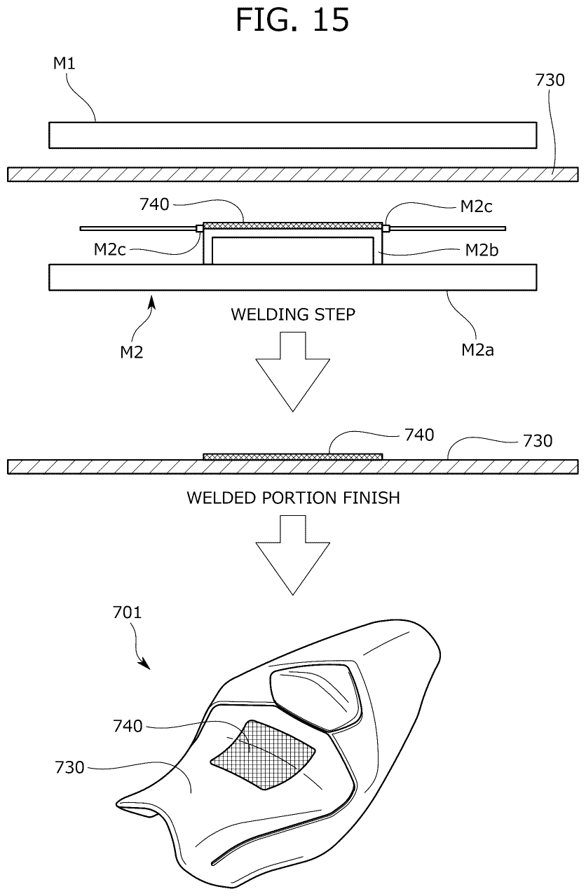

FIG. 15 is a view showing another method for forming the decorative member 740 (decorative skin material).

As shown in FIG. 15, the decorative member 740 can be suitably attached by welding the decorative member 740 onto the skin material 730 serving as a base using an upper mold M1 and a lower mold M2.

The lower mold M2 includes a mold body M2a; a support base M2b placed on the mold body M2a; and a burr suppression member M2c provided at an outer edge portion of the support base M2b and slightly protruding from the support base M2b. The burr suppression member M2c is a member that suppresses the occurrence of burrs during molding.

By using the molds M1 and M2, the occurrence of burrs at a welded portion of the decorative member 740 can be suppressed, and the finish of the decorative member 740 can be made good. Specifically, a cutting surface of the skin material 730 serving as a base can be finished not to be exposed.

Incidentally, the shape and disposition of the burr suppression member M2c may be arranged such that both end portions of the decorative member 740 have a tapered shape (slope shape). As a result, connection between the skin material 730 and the decorative member 740 can be made smooth.

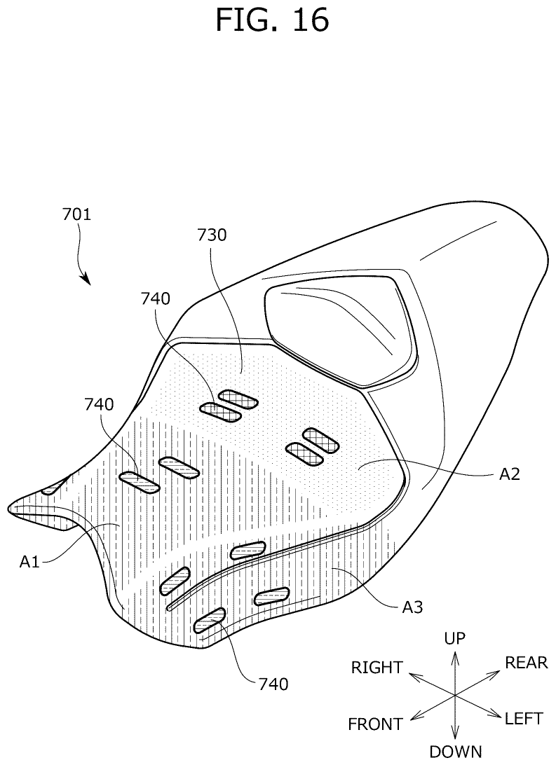

FIG. 16 is a perspective view of the conveyance seat 701, and is a view showing the form of the decorative members 740.

A plurality of the decorative members 740 are attached to the surface of the conveyance seat 701. Specifically, the decorative members 740 are disposed in a front region A1, an ischium corresponding region A2, and right and left side regions A3 of the conveyance seat 701.

In this case, by appropriately changing the hardness (hardness) of the decorative members 740 according to each of the regions A1 to A3, the seating comfort (ride comfort) of the conveyance seat 701 can be improved.

Specifically, it is preferable that the hardness of the decorative members 740 is set to be softer in the ischium corresponding region A2 where the seating weight is larger and the peak pressure is higher than in the other regions A1 and A3. As a result, a reduction in pressure can be achieved.

In addition, it is preferable that the hardness of the decorative members 740 is set to be relatively hard in the right and left side regions A3 which come into contact with the legs (thighs) of a seated occupant and which are held by the seated occupant.

In addition, it is preferable that the hardness of the decorative members 740 is set to be relatively hard in the front region A1 where a load is applied when the motorcycle V2 is braked.

In addition, it is preferable that the decorative members 740 are disposed in the ischium corresponding region A2 at positions that fit between the ischia of the seated occupant, and have a size that fits between the ischia of the seated occupant. As a result, discomfort of the seated occupant when seated can be reduced.

In addition, in order to suppress discomfort during seating, recesses may be formed at portions of the pad material 720, to which the decorative members 740 are attached. Alternatively, protrusions may be formed around portions of the pad material 720, to which the decorative members 740 are attached.

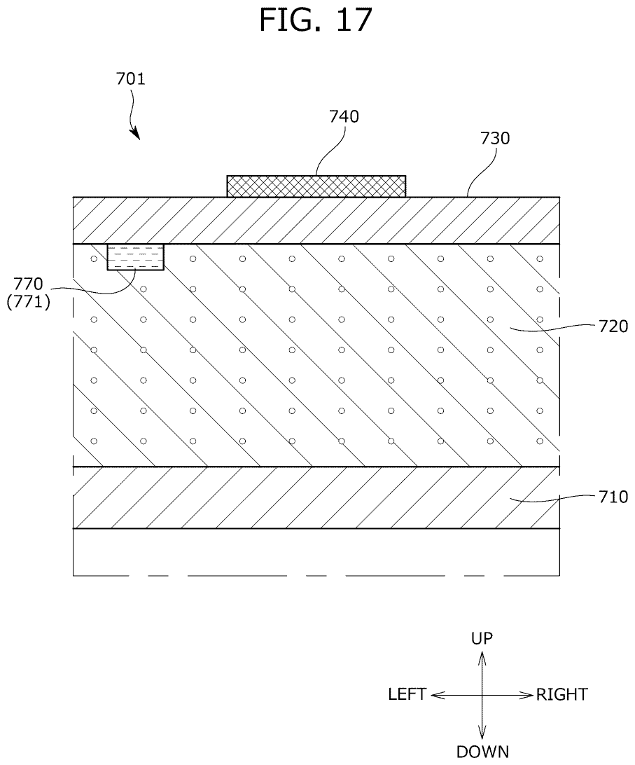

In addition, as shown in FIG. 17, when a seat heater 770 is attached inside the conveyance seat 701, it is preferable that a heater wire 771 and the decorative member 740 are disposed at different positions in the front to rear direction or the width direction of the conveyance seat 701. As a result, the deformation and discoloration of the decorative members 740 due to heat of the heater wire 771 can be suppressed.

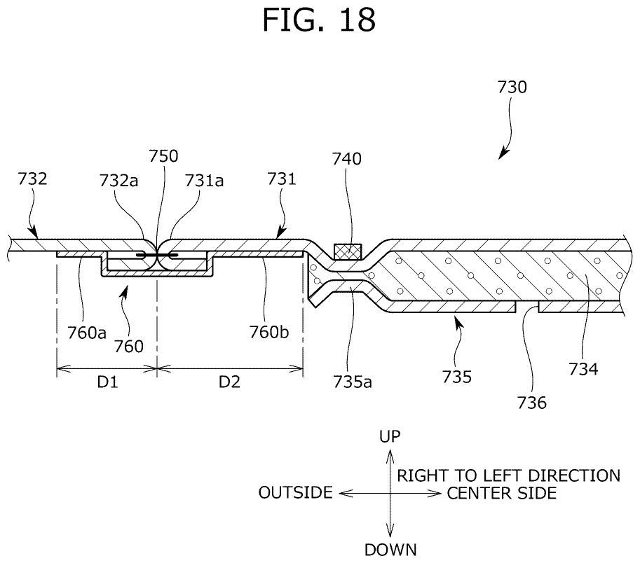

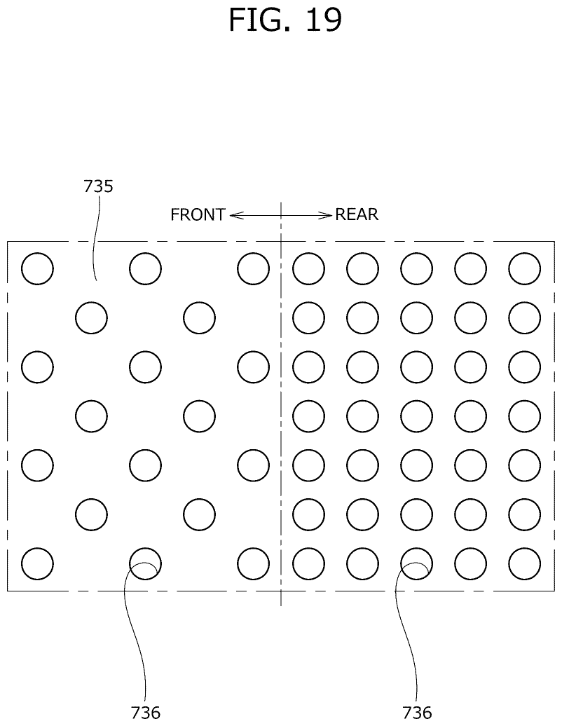

FIG. 18 is a cross-sectional view of the conveyance seat, and is a view showing the decorative member, a stitching line, and waterproof tape.

As shown in FIG. 18, the skin material 730 includes a first skin material 731 (first skin piece) constituting an upper surface, side surfaces, and a rear surface of the conveyance seat 701; a second skin material 732 (second skin piece) constituting lower portions of the side surfaces and a lower portion of the rear surface of the seat 1; a wadding material 734 disposed on a back surface of the first skin material 731; and a lining material 735 attached to the back surface of the first skin material 731.

A skin terminal portion 731a of the first skin material 731 and a skin terminal portion 732a of the second skin material 732 are connected to each other by stitching to form a stitching line 750.

Waterproof tape 760 is attached to a back surface of each of the skin terminal portion 731a and the skin terminal portion 732a.

In addition, first skin material 731 and a terminal portion 735a of the lining material 735 are welded together, and the wadding 734 material (urethane material) is sandwiched between the first skin material 731 and the lining material 735. In detail, when the decorative member 740 is welded to the first skin material 731, the lining material 735 is simultaneously welded, together with the decorative member 740.

In the above-described configuration, as shown in FIG. 18, it is preferable that a distance D1 of at least 15 mm is ensured between the stitching line 750 and an outer end portion 760a of the waterproof tape 760. As a result, the attachment work of the waterproof tape 760 can be facilitated.

It is preferable that the distance D1 between the stitching line 750 and the outer end portion 760a of the waterproof tape 760 is 15 mm to 17 mm. As a result, the attachment work of the waterproof tape 760 can be facilitated while maintaining a good appearance of the conveyance seat 701.

In the above-described configuration, as shown in FIG. 18, it is preferable that a distance D2 between the stitching line 750 and an inner end portion 760b of the waterproof tape 760 is larger than the distance D1 between the stitching line 750 and the outer end portion 760a of the waterproof tape 760.

As a result, the entry of water (rainwater) into the wadding material 734 can be effectively suppressed.

In the above-described configuration, as shown in FIG. 18, the waterproof tape 760 and the lining material 735 are disposed at different positions, but are not particularly limited thereto.

Namely, the waterproof tape 760 may be attached to cover the terminal portion 735a of the lining material 735. In other words, as shown in FIG. 18, the waterproof tape 760 may be disposed such that a part of the waterproof tape 760 and the decorative member 740 overlap each other.

As a result, the waterproof tape 760 can ensure the waterproofness of the skin material 730, and increase the strength of a portion where the decorative member 740 and the lining material 735 are welded together. In addition, the distance between the decorative member 740 and the stitching line 750 can be reduced, and the decorativeness (design) of the surface of the conveyance seat 701 can be enhanced.

In the above-described configuration, as shown in FIG. 18, a plurality of holes 736 for ensuring breathability are formed on a back surface of the lining material 735.

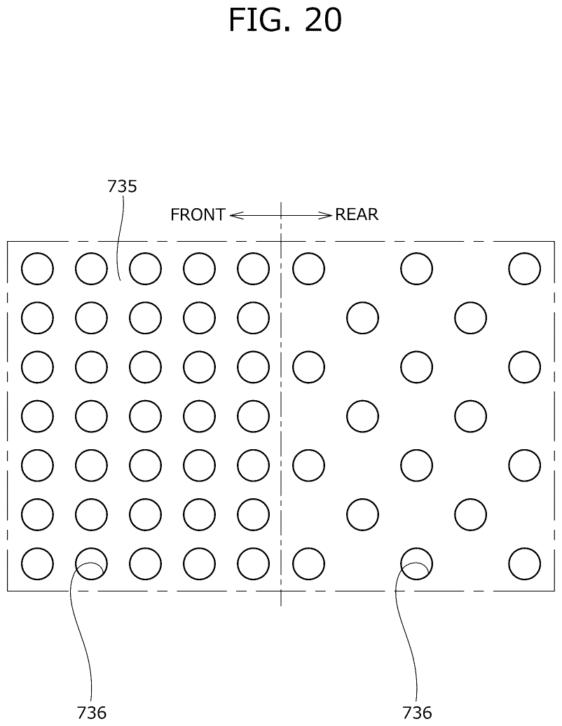

FIG. 19 is a view showing a disposition pattern of the holes 736 formed in the lining material 735.

It is preferable that a total area of the holes 736 formed in a front portion of the lining material 735 in the front to rear direction of the conveyance seat 701 is smaller than a total area of the holes 736 formed in a rear portion of the lining material 735.

As a result, when a brake (sudden brake) is applied to the motorcycle V2, air slowly escapes from the holes 736 in a front portion of the conveyance seat 701, to which the seating weight is applied, so that the cushioning properties of the seat 701 can be maintained.

FIG. 20 is a view showing a Modification example of the disposition pattern of the holes 736.

As shown in FIG. 20, a total area of the holes 736 formed in the front portion of the lining material 735 may be larger than a total area of the holes 736 formed in the rear portion of the lining material 735.

Generally, when the motorcycle V2 is stopped, the legs of the seated occupant are posed to land on the ground on the motorcycle V2, and a large seating weight is applied to the front portion of the conveyance seat 701. At this time, air quickly escapes from the holes 736 in the front portion, so that the foot placement of the seated occupant can be improved.

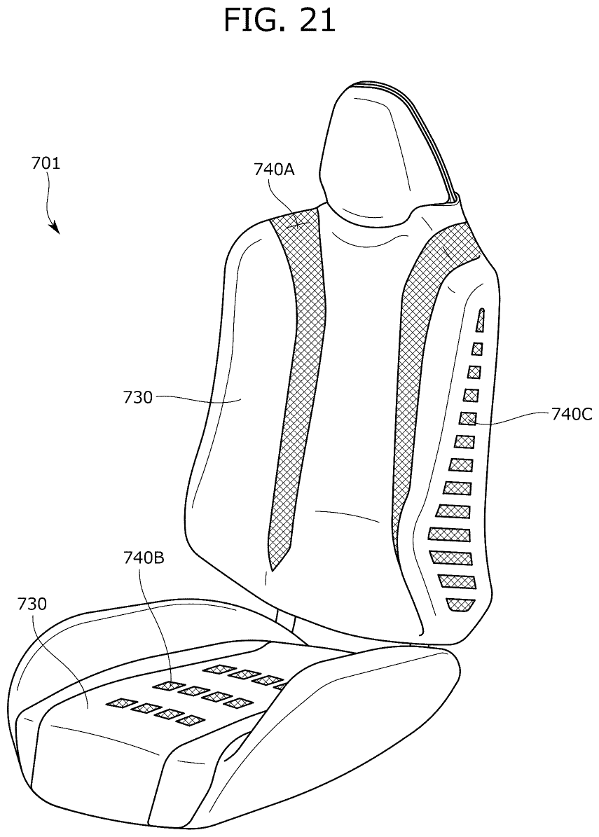

FIG. 21 is a view showing Modification example 2-3 of the decorative member, and is a perspective view of a vehicle seat.

As shown in FIG. 21, a decorative member 740A having a line shape, a decorative member 740B having a dot shape, a decorative member 740C having a stripe shape, and the like can be attached to the skin material 730 of the vehicle seat.

In such a manner, various design needs can be dealt with.

### Third Embodiment

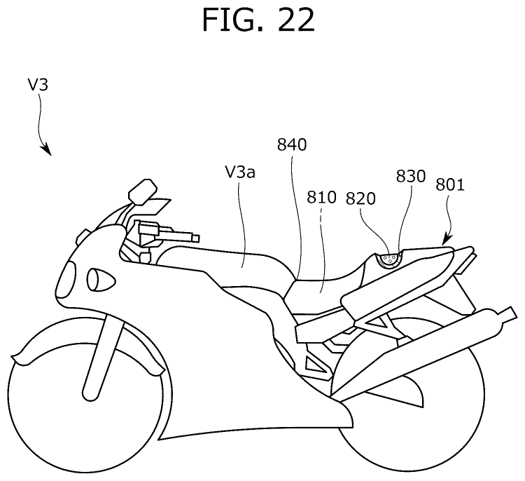

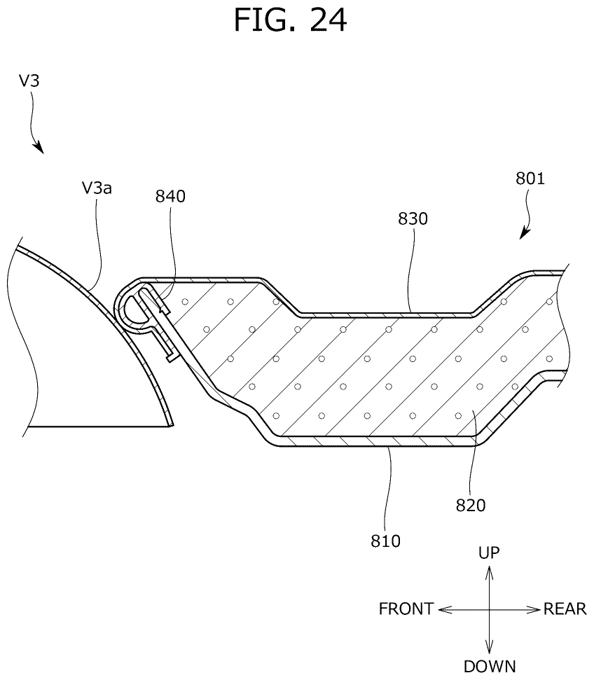

Next, a conveyance seat 801 of a third embodiment will be described based on FIGS. 22 to 29. Incidentally, the description of contents that overlap with those of the conveyance seats 1 and 701 described above will be omitted.

The conveyance seat 801 includes a trim member that abuts against an exterior cover (fuel tank cover) of a motorcycle, and can improve the fixation of the trim member.

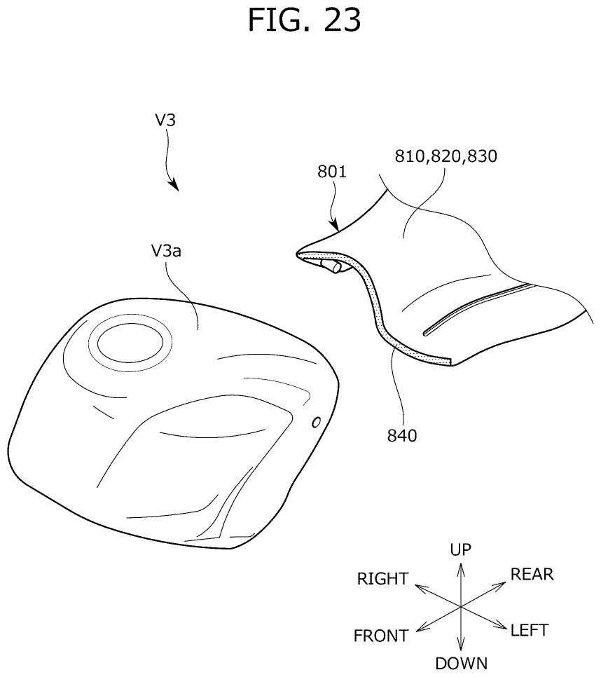

As shown in FIGS. 22 and 23, the conveyance seat 801 is a seat constituting a seating portion of a motorcycle V3, and includes a bottom plate 810; a pad material 820; a skin material 830; and a trim member 840 having flexibility and attached to a front end portion of the bottom plate 810.

As shown in FIGS. 23 to 25, the trim member 840 has a shape along a front end portion of the bottom plate 810, and is inserted and attached to the front end portion of the bottom plate 810.

The trim member 840 is fixed to the front end portion of the bottom plate 810, abuts against an exterior cover V3a (fuel tank cover) located at a position in front of the bottom plate 810, and is in close contact with the exterior cover V3a.

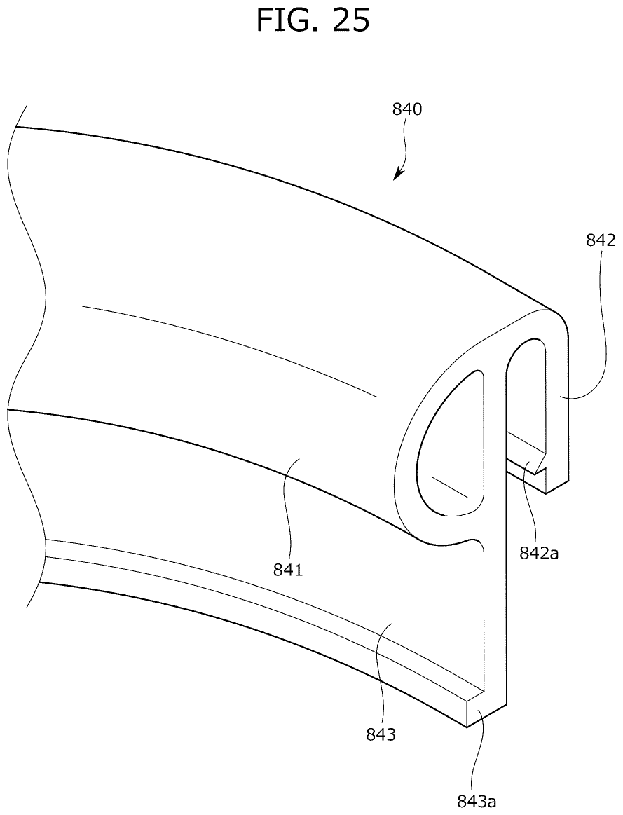

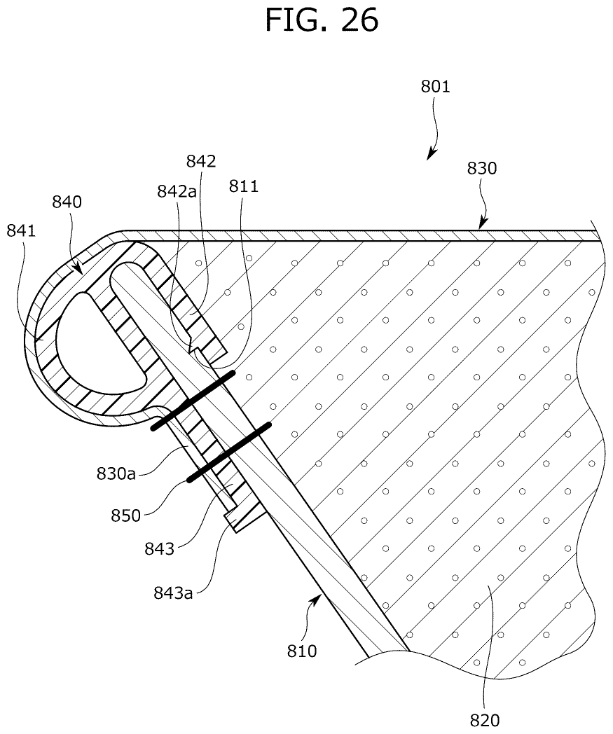

Specifically, as shown in FIGS. 25 and 26, the trim member 840 includes a trim body portion 841 having a hollow shape; a trim engagement portion 842 that protrudes rearward from an upper end portion of the trim body portion 841, and that engages with the bottom plate 810; and a trim extension portion 843 extending downward from a lower end portion of the trim body portion 841 and supported by the bottom plate 810.

In addition, the trim member 840 includes an engagement projection 842a that protrudes from the trim engagement portion 842 toward the bottom plate 810, and that engages with an engagement groove 811 of the bottom plate 810.

In addition, the trim member 840 includes a positioning portion 843a (positioning protrusion) that protrudes from the trim extension portion 843 toward a side opposite to a bottom plate 810 side, and that abuts against a skin terminal portion 830a of the skin material 830.

The front end portion of the bottom plate 810, the skin terminal portion 830a of the skin material 830, and the trim member 840 (trim extension portion 843) are connected to each other by a connecting member 850 (staple).

With the above-described configuration, the fixation (binding) of the trim member 840 can be improved.

In the above-described configuration, as shown in FIG. 26, each of a base end portion and an extension end portion of the trim extension portion 843 is connected to the bottom plate 810 by the connecting member 850. In addition, the skin material 830 is connected by the connecting member 850, together with the trim extension portion 843.

As a result, a contact area between the bottom plate 810 and the trim member 840 (trim extension portion 843) can be increased, and the trim member 840 can be firmly fixed.

In addition, a contact area between the trim member 840 and the skin material 830 can be increased, and the trim member 840 and the skin material 830 can be firmly connected to each other.

In the above-described configuration, as shown in FIG. 26, the engagement projection 842a of the trim member 840 is latched into the engagement groove 811 of the bottom plate 810.

As a result, the trim member 840 can be firmly fixed to the bottom plate 810. In addition, the trim member 840 is easily positioned.

Incidentally, the engagement projection 842a is not limited to a triangular cross-sectional shape, and may have various shapes such as a quadrilateral cross-sectional shape and a circular cross-sectional shape.

In the above-described configuration, as shown in FIG. 26, the trim member 840 includes the positioning portion 843a for determining an attachment position of the skin material 830.

As a result, the attachment position of the skin material 830 becomes clear, and the attachment work of the skin material 830 becomes facilitated.

Incidentally, the positioning portion 843a may not be limited to a protruding shape. For example, the positioning portion 843a may be a print portion printed (marked) on a surface of the trim extension portion 843.

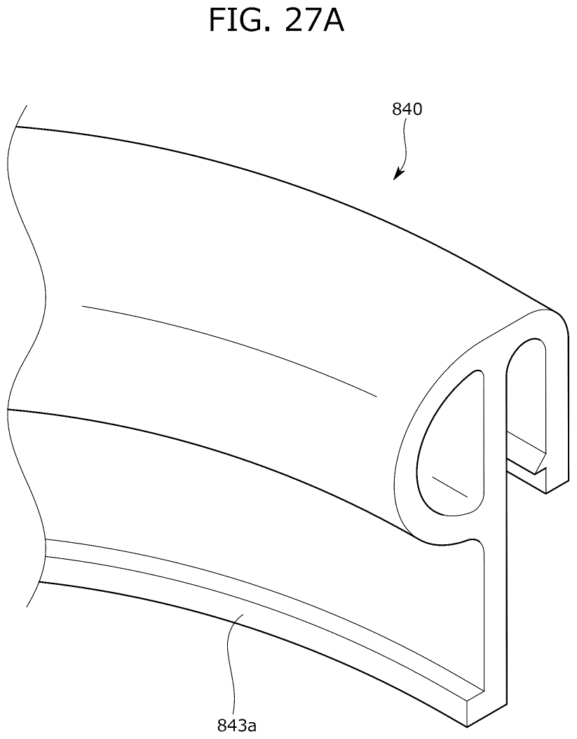

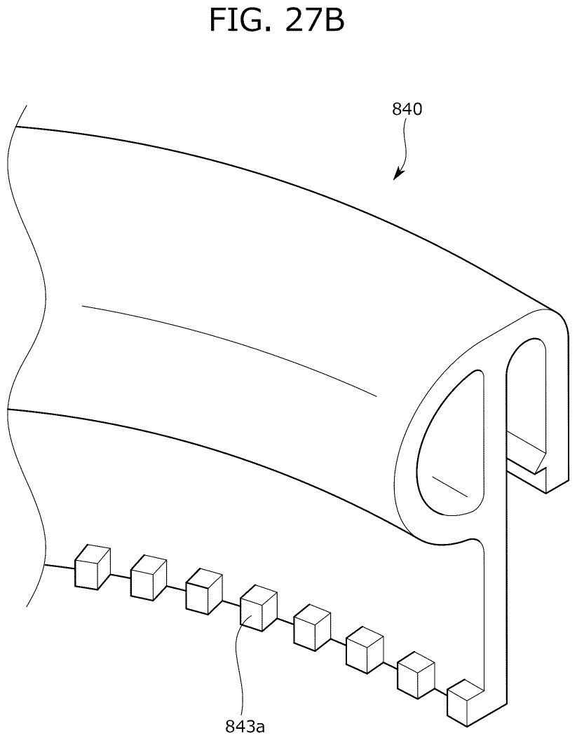

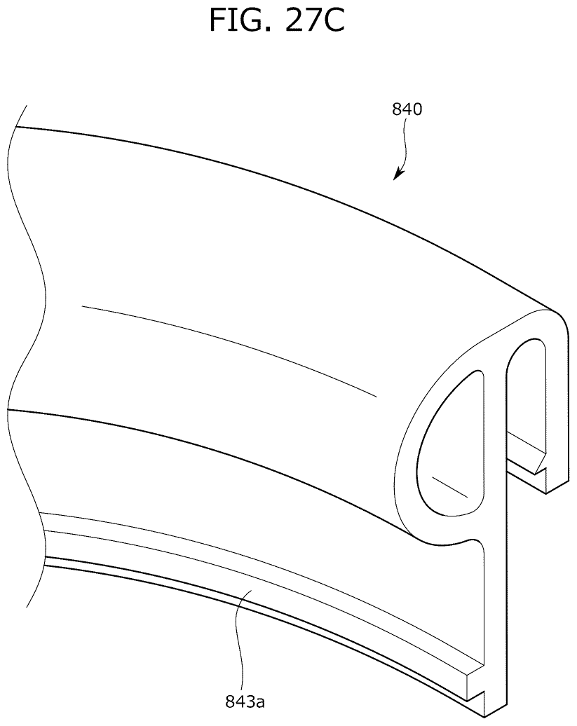

FIG. 27A is a perspective view of the trim member 840, and is a view showing the positioning portion 843a.

The positioning portion 843a extends long along a longitudinal direction of the trim member 840, but may not be particularly limited thereto. For example, as shown in FIG. 27B, a plurality of the positioning portions 843a may be disposed at intervals in the longitudinal direction of the trim member 840.

In addition, the positioning portions 843a are disposed at the extension end portion of the trim member 840 (trim extension portion 843), but may not be particularly limited thereto. For example, as shown in FIG. 27C, the positioning portion 843a may be disposed at a position between the base end portion and the extension end portion of the trim extension portion 843.

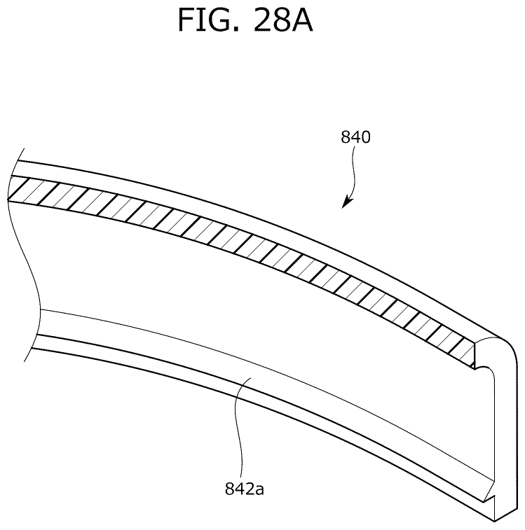

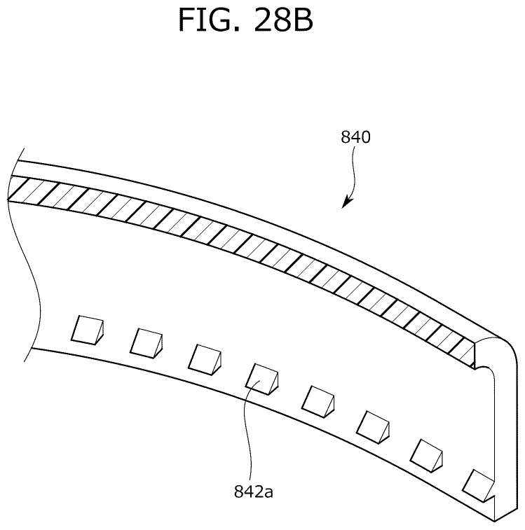

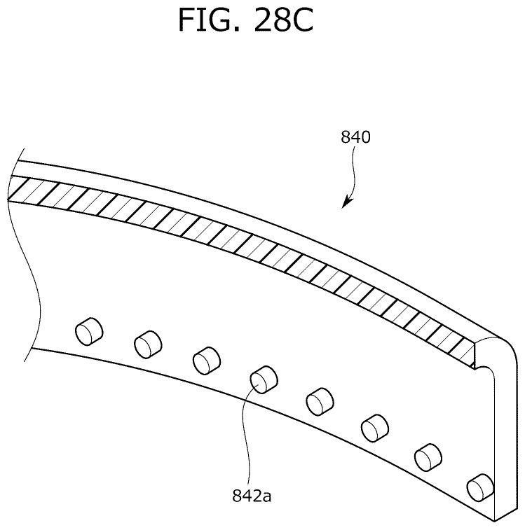

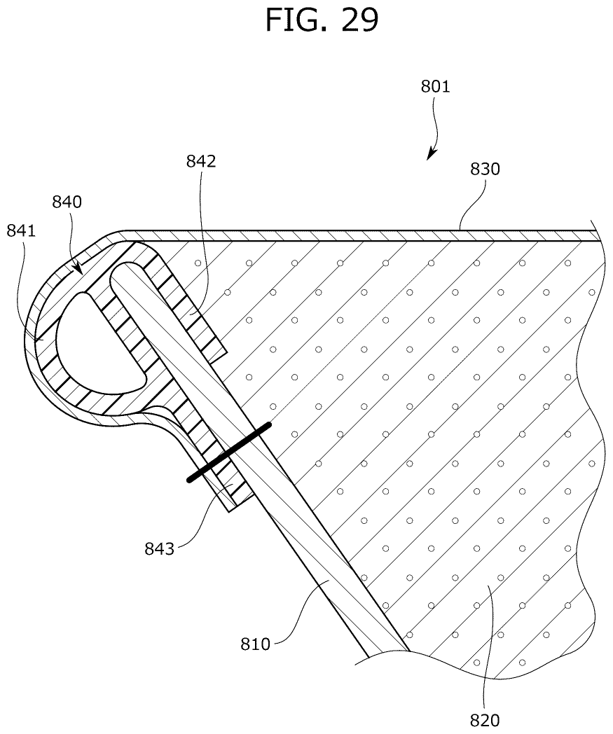

FIG. 28A is a cross-sectional view of the trim member 840, and is a view showing the engagement projection 842a. The engagement projection 842a extends long along the longitudinal direction of the trim member 840, but may not be particularly limited thereto. For example, as shown in FIG. 28B, a plurality of the engagement projections 842a may be disposed at intervals in the longitudinal direction of the trim member 840.

In addition, the engagement projections 842a have a triangular vertical cross-sectional shape, but may not be particularly limited thereto. For example, as shown in FIG. 28C, the engagement projections 842a may have a circular column shape, and may be disposed at predetermined intervals. The engagement projections 842a may have various shapes such as a triangular prism shape.

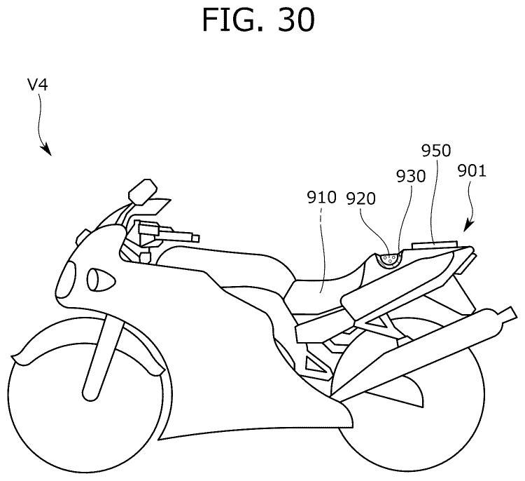

FIG. 29 shows a Modification example of the trim member 840.

As shown in FIG. 29, the trim member 840 having a simple shape may be adopted.

Specifically, the trim member 840 may include the trim body portion 841 having a hollow shape, the trim engagement portion 842, and the trim extension portion 843.

### Fourth Embodiment

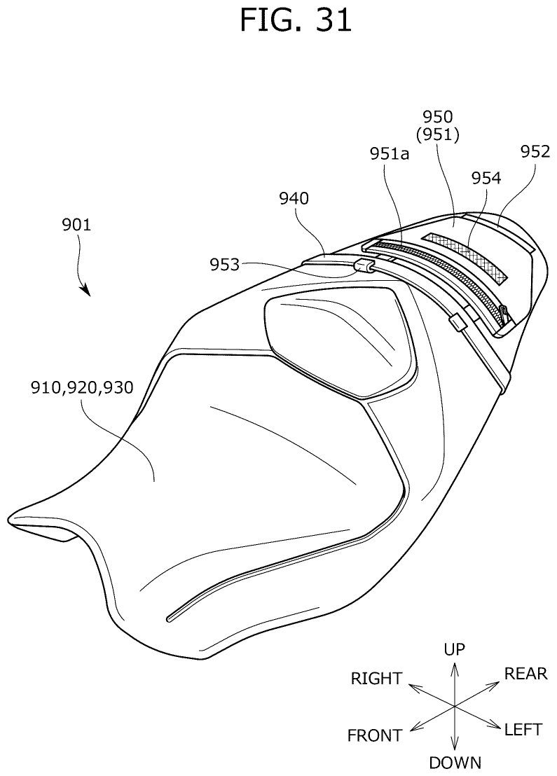

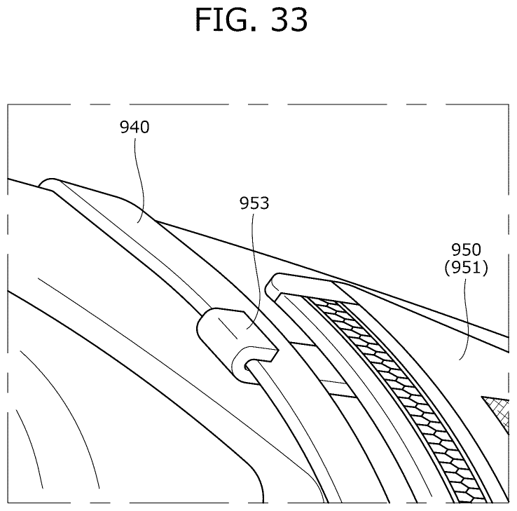

Next, a conveyance seat 901 of a fourth embodiment will be described based on FIGS. 30 to 35. Incidentally, the description of contents that overlap with those of the conveyance seats 1, 701, and 801 described above will be omitted.

The conveyance seat 901 includes a pocket (storage pocket) that can be fixed to an upper surface of the seat, and can store the pocket when the pocket is not in use.

As shown in FIGS. 30 to 32, the conveyance seat 901 is a seat constituting a seating portion of a motorcycle V4, and includes a bottom plate 910; a pad material 920; a skin material 930; a tandem belt 940; and a pocket 950 (storage pocket) that is attached to a surface of the skin material 930, and that is attached to and detached from the tandem belt 940.

The pocket 950 is disposed at a position behind the tandem belt 940. Namely, the pocket 950 is disposed at a position avoiding a seating portion of a driver (seated occupant) of the motorcycle V4. As a result, a decrease in the seating comfort of the driver can be suppressed.

The tandem belt 940 is a grip-type auxiliary belt that is fixed to a body of the conveyance seat 901, and that supports a rear occupant not to fall off when a plurality of occupants ride the motorcycle V4.

The tandem belt 940 is disposed at a rear position of the conveyance seat 901, extends long in a width direction of the conveyance seat 901, and is fixed to wrap around the conveyance seat 901.

The pocket 950 is a storage pocket including an opening portion 951a with a fastener, and capable of storing small items such as a mobile terminal, gloves, and a wallet.

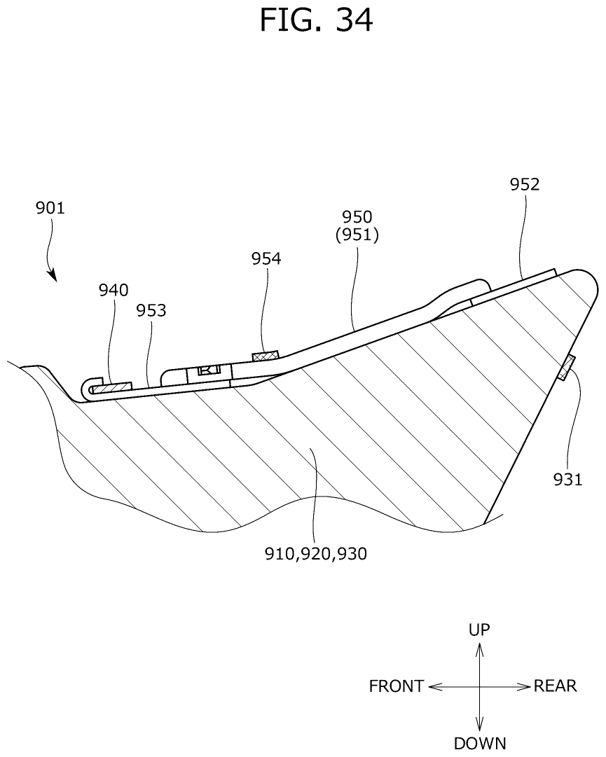

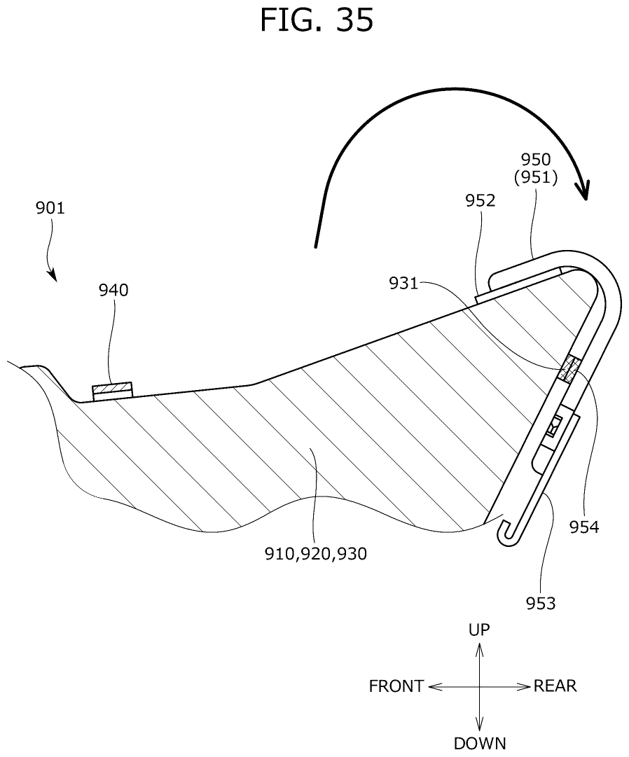

The pocket 950 is switchable between a “use position” shown in FIG. 34 and a “storage position” shown in FIG. 35.

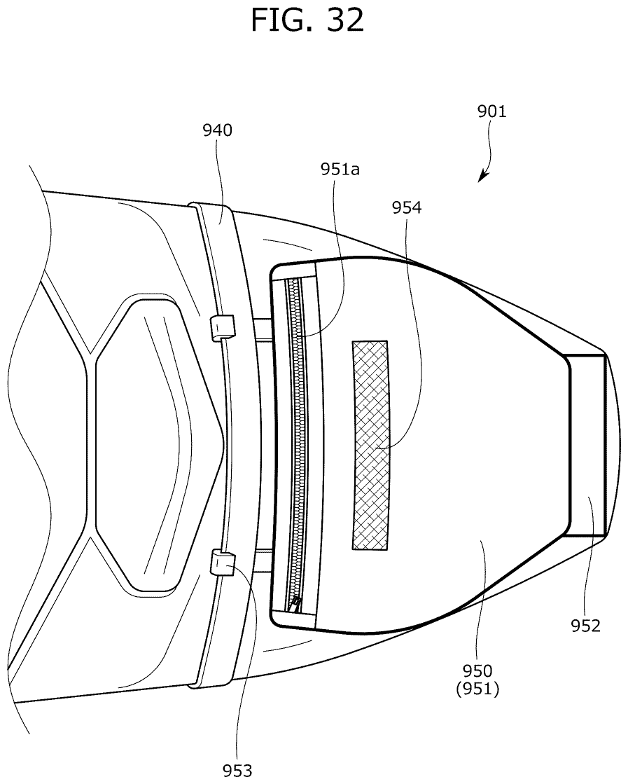

As shown in FIGS. 32 to 35, the pocket 950 includes a pocket body 951; a pocket attachment portion 952 provided at a rear end portion of the pocket body 951 and fixed to the surface of the skin material 930; a pocket engagement portion 953 that is provided at a front end portion of the pocket body 951, and that engages with the tandem belt 940; and a pocket attachment/detachment portion 954 provided on a surface of the pocket body 951.

The pocket body 951 is a body of the storage pocket, and is made of, for example, a mesh material. As a result, water is less likely to accumulate, and even when the pocket 950 is wet, the pocket 950 can be easily dried.

The pocket attachment portion 952 is an attachment member for fixing the pocket body 951, and is made of a stretchable material. The pocket attachment portion 952 is fixed to an upper surface of a rear end portion of the skin material 930.

The pocket engagement portion 953 is an engagement hook that detachably engages with the tandem belt 940, and extends from the pocket body 951 toward the front of the seat.

Incidentally, the pocket engagement portion 953 engages with the tandem belt 940 provided on the conveyance seat 901, but is not particularly limited thereto. For example, the pocket engagement portion 953 may detachably engage with an engaged portion on the surface of the conveyance seat 901.

The pocket attachment/detachment portion 954 is a hook-and-loop fastener, and is fixed to an upper surface of the pocket body 951 as shown in FIG. 34.

In addition, as shown FIG. 35, the pocket attachment/detachment portion 954 is attachably/detachably attached to an attached portion 931 provided on a rear surface of the body portion of the conveyance seat 901.

With the above-described configuration, as shown in FIGS. 34 and 35, the pocket 950 is easily switchable between the “use position” and the “storage position”.

When the pocket 950 is at the “use position”, the pocket 950 is disposed at a position (a rear end position of the seat 901) that is easily reachable by the occupant (seated occupant).

For this reason, the pocket 950 can be used to suitably store a small item such as a mobile terminal or gloves.

On the other hand, when the pocket 950 is at the “storage position”, the pocket 950 is stored in the rear surface of the conveyance seat 901.

For this reason, when the pocket 950 is not in use, or when the pocket 950 is desired to be stored, the pocket 950 can be disposed at a position that is not visible from the outside (a position that is difficult to see). Namely, the pocket 950 can be provided without impairing the appearance of the motorcycle V4.

Generally, there are vehicle models in which motorcycle seats do not have a space for storing small items inside the seats. For this reason, small items can be stored on the upper surface of the seat by using the pocket 950. In addition, when the pocket 950 is not in use, the pocket 950 can be put away to an inconspicuous position.

In the first to fourth embodiments, the motorcycle seats directly exposed to sunlight or directly exposed to wind and rain or snow have been described as specific examples; however, the present invention is not particularly limited thereto, and can be used in saddle-type conveyance seats of conveyances used outdoors, such as snow bikes, water bikes, and all-terrain vehicles (buggies).

In addition, the above-described conveyance seats can be used not only as saddle-type conveyance seats, but also as vehicle seats for automobiles, trains, and buses and conveyance seats for airplanes and ships.

In the first to fourth embodiments, the conveyance seats according to the present invention have been mainly described.

However, the embodiments are merely examples provided to facilitate understanding of the present invention, and do not limit the present invention. The present invention can be changed and improved without departing from the concept of the present invention, and it goes without saying that the present invention includes its equivalents.

### REFERENCE SIGNS LIST

<First embodiment>
V1: motorcycle (conveyance)
V1a: vehicle body (body of conveyance)
1: conveyance seat (seat)
10: bottom plate
11: plate body portion
12: plate outer peripheral portion
13: attachment member (tacker needle)
20: pad material
21: pad body portion
22: pad projecting portion
30, 130, 230, 330, 430, 530, 630: skin material
430a: accommodation recess
31, 131, 231, 331, 531, 631: first skin material
31a, 31b, 531a, 631a: skin terminal portion
31c, 131c, 231c: first overlapping portion
331c: first folded portion
32, 132, 232, 332, 532, 632: second skin material
32a, 32b, 532a, 632a: skin terminal portion
32c, 132c, 232c: second overlapping portion
332c: second folded portion
33: third skin material
33a: skin terminal portion
40, 140, 240, 340, 440, 540, 640: decorative member (bead)
40a, 140a, 240a, 340a, 440a, 540a, 640a: exposed surface
41, 241, 541: decorative portion
42, 242, 542: base portion
42a: first projecting portion
42b: second projecting portion
50, 150, 250, 350, 550, 650: stitching line
160, 560: second stitching line
450: adhesive agent
<Second embodiment>
V2: motorcycle (conveyance)
701: conveyance seat (seat)
710: bottom plate
720: pad material
730: skin material
731: first skin material
731a: skin terminal portion
732: second skin material
732a: skin terminal portion
734: wadding material
735: lining material
735a: terminal portion
736: hole
740, 740A, 740B, 740C: decorative member
750: stitching line
760: waterproof tape
760a: outer end portion
760b: inner end portion
770: seat heater
771: heater wire
A1: front region
A2: ischium corresponding region
A3: side region
D1: distance
D2: distance
M: mold
Ma: protruding portion
M1: upper mold
M2: lower mold
M2a: mold body
M2b: support base
M2c: burr suppression member
<Third embodiment>
V3: motorcycle (conveyance)
V3a: exterior cover
801: conveyance seat (seat)
810: bottom plate
811: engagement groove
820: pad material
830: skin material
830a: skin terminal portion
840: trim member
841: trim body portion
842: trim engagement portion
842a: engagement projection
843: trim extension portion
843a: positioning portion
850: connecting member
<Fourth embodiment>
V4: motorcycle (conveyance)
901: conveyance seat (seat)
910: bottom plate
920: pad material
930: skin material
931: attached portion
940: tandem belt (belt)
950: pocket (storage pocket)
951: pocket body
951a: opening portion
952: pocket attachment portion
953: pocket engagement portion (engagement hook)
954: pocket attachment/detachment portion (hook-and-loop
fastener)

1. A conveyance seat, comprising:
a pad material;
a skin material covering the pad material; and
a decorative member formed separately from the skin material, and attached to the skin material to be exposed on a surface of the conveyance seat,
wherein an exposed surface of the decorative member exposed on the surface of the conveyance seat and a surface of the skin material are substantially flush with each other.

2. The conveyance seat according to claim 1,
wherein the decorative member has a three-dimensional shape, and
the exposed surface extends long along the surface of the conveyance seat.

3. The conveyance seat according to claim 1,
wherein a bottom plate, the pad material disposed on the bottom plate, and the skin material covering the bottom plate and the pad material are provided,
a skin terminal portion that is a terminal portion of the skin material is attached to the bottom plate, and
the decorative member is disposed on a portion of the surface of the conveyance seat, the portion coming into contact with a seated occupant when the seated occupant is seated on the conveyance seat.

4. The conveyance seat according to claim 1,
wherein the decorative member is stitched and attached to the skin material.

5. The conveyance seat according to claim 4,
wherein a stitching line is formed on the surface of the skin material by stitching the decorative member,
the exposed surface of the decorative member extends long along the surface of the conveyance seat, and
the stitching line extends long at a predetermined interval from the exposed surface, together with the exposed surface.

6. The conveyance seat according to claim 1,
wherein the decorative member includes a decorative portion having the exposed surface, and a base portion which is provided on a surface on an opposite side of the decorative portion from an exposed surface side, and to which a part of the skin material is attached by stitching.

7. The conveyance seat according to claim 6,
wherein the base portion is formed to be wider than the decorative portion, and
a projecting portion of the base portion which projects from the decorative portion is stitched to the part of the skin material.

8. The conveyance seat according to claim 1,
wherein the skin material includes a first skin material and a second skin material,
the first skin material and the second skin material are connected to each other via the decorative member,
the first skin material includes a first overlapping portion where a skin terminal portion overlaps in a thickness direction of the skin material by folding the skin terminal portion to a pad material side, the skin terminal portion being located on a second skin material side,
the second skin material includes a second overlapping portion where a skin terminal portion overlaps in the thickness direction of the skin material by folding the skin terminal portion to the pad material side, the skin terminal portion being located on a first skin material side, and
each of the first overlapping portion and the second overlapping portion is attached to the decorative member.

9. The conveyance seat according to claim 8,
wherein the decorative member includes a decorative portion having the exposed surface, and a base portion which is provided on a surface on an opposite side of the decorative portion from an exposed surface side, and to which the skin terminal portions of the skin material are attached by stitching, and
the decorative member is attached between the first skin material and the second skin material by stitching together the first overlapping portion and the base portion, and stitching together the second overlapping portion and the base portion.

10. The conveyance seat according to claim 9,
wherein the base portion is formed to be wider than the decorative portion,
a first projecting portion of the base portion which projects from the decorative portion is stitched to the skin terminal portion of the first skin material,
a second projecting portion of the base portion which projects toward a side opposite to the first projecting portion is stitched to the skin terminal portion of the second skin material, and
the exposed surface of the decorative member and right and left stitching lines formed at intervals on both sides of the exposed surface extend long along the surface of the conveyance seat.
